(19) United States
(12) Patent Application Publication
(10) Pub. No.: US 2010/0093583 A1
(43) Pub. Date: Apr. 15, 2010

(54) FOAMING CLEANSING COMPOSITION

(75) Inventors: Odile AUBRUN-SONNEVILLE, Antony (FR); Laurence Sebillotte-Arnaud, L'Hay Les Roses (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: L'OREAL, Paris (FR)

(21) Appl. No.: 12/635,947

(22) Filed: Dec. 11, 2009

Related U.S. Application Data
(63) Continuation of application No. 11/186,909, filed on Jul. 22, 2005, now abandoned.

(30) Foreign Application Priority Data
Jul. 26, 2004 (FR) 0451653

(51) Int. Cl. C11D 1/04

(52) U.S. Cl. 510/119; 510/405; 510/421

(57) ABSTRACT

The invention relates to a composition containing at least one carboxylic ionic surfactant and at least one amphoteric surfactant of the betaine type. The invention composition is preferably a foaming cleansing composition which can be rinsed off with water. The invention further relates to the various uses of the described composition, for example in the cosmetics and dermatological fields, in particular as a product for cleansing or removing makeup from the skin, scalp and/or the hair.

### REFERENCE TO PRIOR APPLICATIONS

This application claims priority to French patent application 0451653 filed Jul. 26, 2004, incorporated herein by reference.

### FIELD OF THE INVENTION

The invention relates to a foaming cleansing composition comprising at least one ionic carboxylic surfactant and at least one oxyethylenated compound. Preferably, the composition is water-rinsable, and has the appearance of a transparent gel. The invention further relates to the uses of the disclosed composition in the fields of cosmetics and dermatology, especially as a product for cleansing or for removing makeup from the skin, the scalp and/or the hair.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Cleansing of the skin is very important for facial care. It should be as efficient as possible, since fatty residues such as excess sebum, residues of the cosmetic products used daily and makeup products, especially waterproof products, accumulate in the folds of the skin and can obstruct the skin pores and lead to the formation of spots.

It is known practice to use foaming detergent aqueous gels to cleanse the skin. Their cleansing action is provided by the surfactants they contain, these surfactants holding in suspension the fatty residues and the pigments of the makeup products. These gels are efficient and pleasant to use since they foam. It is especially sought to make foaming cleansing gels transparent, since, just like water, transparency is a symbol of purity and thus of cleanliness, and transparent gels are thus particularly appreciated by users. The foaming transparent gels intended for cleansing the face or the body very often generate light, airy foams. However, after rinsing, the skin is often slippery and no sensation of clean skin remains because of the presence of a film-forming residue on the skin, which is difficult to remove. One way of obtaining dense foams with fine bubbles that rinse off rapidly without leaving a film consists in using soaps (fatty acid salts) as main surfactants. However, compositions with soap are less well tolerated, particularly by individuals with sensitive skin, since they give a sensation of dryness and may be irritant. In addition, they are not transparent but usually opaque, on account of the low solubility of the soaps.

### SUMMARY OF THE INVENTION

There is thus a need for a foaming composition such as a transparent gel not comprising soap and having a good foam quality, while at the same time having a good rinsing quality and good eye and skin tolerance.

The inventors have found, surprisingly, that a foaming transparent gel that has both good cosmetic properties (foam qualities and rinsing quality) and good tolerance properties is obtained by using as surfactant at least one alkyl glycol carboxylate, and by combining therewith at least one oxyethylenated compound with a molecular weight of greater than 300 000 g/mol.

Admittedly, foaming compositions containing oxyethylenated compounds are known in the prior art. Thus, document JP-A-05/043 434 describes shampoos containing surfactants of alkyl saccharide type and polyethylene glycols with a molecular weight of greater than 500 000 g/mol. However, the combination described leads to compositions that are not homogeneous, but separate out into two phases.

Document JP-A-03/174 497 describes detergent liquid compositions containing a fatty ester of fructose and a polyethylene glycol with a molecular weight of between 194 g/mol and 10 000 g/mol. However, the foaming properties of such a composition prove to be insufficient.

The composition according to the invention has the advantage of being stable, non-irritant and of having good foam qualities.

### DETAILED DESCRIPTION OF THE PREFERRED EMBODIMENTS

One subject of the present patent application is a cleansing composition preferably suitable for topical application, containing, in a physiologically acceptable aqueous medium, at least one anionic surfactant chosen from alkyl glycol carboxylic acids and salts thereof, and at least one oxyethylenated compound with a molecular weight of greater than or equal to 300 000 g/mol.

The term “topical application” means herein an external application to keratin materials, which are especially the skin, the scalp, the eyelashes, the eyebrows, the nails, the hair and/or mucous membranes. Since the composition is intended for topical application, it comprises a physiologically acceptable medium. Moreover, the term “physiologically acceptable medium” means a medium that is compatible with the skin, the lips, the scalp, the eyelashes, the eyes, the nails and/or the hair. The composition may especially constitute a cosmetic or dermatological composition.

Moreover, the term “aqueous medium” means a medium comprising at least 35% by weight of water, preferably ranging from 35% to 98% by weight and better still from 40% to 80% by weight relative to the total weight of the composition. The aqueous medium of the foaming compositions of the invention may contain, for example besides water, one or more surfactants chosen from lower alcohols containing from 1 to 6 carbon atoms, such as ethanol; polyols such as glycerol, glycols, for instance butylene glycol, isoprene glycol, propylene glycol and polyethylene glycols with a molecular weight of less than 10 000, such as PEG-8, sorbitol, sugars such as glucose, fructose, maltose, lactose and sucrose; and mixtures thereof. The amount of solvent(s) in the composition of the invention may range from 0.5% to 30% by weight and preferably from 5% to 20% by weight relative to the total weight of the composition.

The compositions of the invention preferably constitute rinsable foaming cleansing compositions, which may be used in the field of cleansing of the skin, the hair or mucous membranes.

The composition according to the invention is preferably in the form of a transparent gel. The word “transparent” means that the composition has a turbidity of less than or equal to 500 NTU. The NTU (Nephelometric Turbidity Units) are units for measuring the turbidity of a composition. The turbidity measurement may be performed, for example, using a model 2100 P turbidimeter from the company Hach Company, the tubes used for the measurement being referenced AR397A cat 24347-06. The measurements are performed at room temperature (20° C. to 25° C.). The transparency of a composition may be measured either by the coefficient of transmittance at 600 nm or by the turbidity. The composition of the invention has a coefficient of transmittance at 600 nm ranging from 10% to 90% or a turbidity ranging from 2 to 500 NTU and preferably from 5 to 300 NTU.

Moreover, the viscosity of the compositions according to the invention preferably ranges from 0.01 to 50 Pa·s, measured using a Rheomat RM180 viscometer from Rheometric Scientific, at 200 rpm (revolutions per minute), measured 10 minutes after the start of rotation of the spindle. The machine is equipped with a different spindle according to the viscosity, for example a No. 2 spindle for viscosity ranges of less than 0.7 Pa·s, a No. 3 spindle for viscosity ranges from 0.2 to 4 Pa·s, and a No. 4 spindle for viscosities of greater than 2.

The compositions of the invention have the advantage of being very stable and of undergoing neither any phase separation nor any recrystallization on storage from 4° C. to 45° C.

### Anionic Surfactant

The composition according to the invention comprises at least one anionic surfactant chosen from alkyl glycol carboxylic acids (or 2-(2-hydroxyalkyl-oxy)acetic acids), salts thereof, and mixtures thereof.

These surfactants may especially have the formula (I) below:

R₁—CHOH—CH₂—O—CH₂—COO⁻X⁺ (I)

in which R₁ denotes a saturated or unsaturated, linear or branched alkyl radical containing from 8 to 30 carbon atoms and X denotes hydrogen or a mineral or organic cation, such as those derived from an alkali metal (for example Na⁺, K⁺), NH₄⁺, ammoniums derived from basic amino acids such as lysine, arginine, sarcosine, ornithine or citrulline, or alternatively amino alcohols such as monoethanolamine, diethanolamine, triethanolamine, glucamine, N-methylglucamine and 3-amino-1,2-propanediol.

The 2-hydroxyalkylcarboxylic acids that are preferred according to the present invention are compounds of formula (I) in which R₁ more particularly denotes a saturated or unsaturated, linear or branched alkyl radical containing from 8 to 18 carbon atoms.

Included among the surfactants of formula (I) that may especially be mentioned are sodium lauryl glycol carboxylate, sold under the names Beaulight SHAA® or Beaulight LCA-25N® by the company Sanyo, or the corresponding acid form thereof sold under the name Beaulight SHAA (Acid Form)® by the company Sanyo.

The amount of anionic surfactants of alkyl glycol carboxylic type may range, for example, from 0.5% to 20% by weight (of active material) and preferably from 1% to 17% by weight relative to the total weight of the final composition.

### Additional Surfactants

The composition according to the invention may comprise, besides the anionic surfactant described above, one or more additional surfactants chosen for example from nonionic, amphoteric and anionic surfactants, and mixtures thereof.

The total amount of surfactants (as active material) may range, for example, from 2% to 50% by weight and preferably from 3% to 20% by weight relative to the total weight of the composition. The weight ratio (as active material) of the surfactant of alkyl glycol carboxylic type relative to the other surfactants preferably ranges from 100/0 to 10/90 and better still from 90/10 to 25/75.

Nonionic Surfactants

Examples of nonionic surfactants that may be used include alkyl polyglucosides (APG), maltose esters, polyglycerolated fatty alcohols, glucamine derivatives, for instance 2-ethylhexyloxycarbonyl-N-methylglucamine, and mixtures thereof.

Alkylpolyglucosides that are preferably used are those containing an alkyl group comprising from 6 to 30 carbon atoms and preferably from 8 to 16 carbon atoms, and containing a hydrophilic group (glucoside) preferably comprising 1.2 to 3 saccharide units. Examples of alkylpolyglucosides that may be mentioned include decylglucoside (alkyl-C9/C11-polyglucoside (1.4)), for instance the product sold under the name Mydol 10® by the company Kao Chemicals, the product sold under the name Plantaren 2000 UP® by the company Cognis, and the product sold under the name Oramix NS 10® by the company SEPPIC; caprylyl/capryl glucoside, for instance the product sold under the name Oramix CG 110® by the company SEPPIC; laurylglucoside, for instance the products sold under the names Plantaren 1200 N® and Plantacare 1200® by the company Cognis; and cocoglucoside, for instance the product sold under the name Plantacare 818/UP® by the company Cognis.

The maltose derivatives are, for example, those described in document EP-A-566 438, such as O-octanoyl-6′-D-maltose or O-dodecanoyl-6′-D-maltose described in document FR-2 739 556.

Among the polyglycerolated fatty alcohols that may be mentioned is polyglycerolated dodecanediol (3.5 mol of glycerol), this product being sold under the name Chimexane NF® by the company Chimex.

According to one preferred embodiment of the invention, the composition contains an alkylpoly-glucoside as additional surfactant.

Amphoteric Surfactants

The amphoteric and zwitterionic surfactants may be chosen, for example, from betaine, amphoacetate and hydroxylsultaine derivatives, and mixtures thereof.

Examples of betaines that may be mentioned include cocobetaine, for instance the product sold under the name Dehyton AB-30® by the company Cognis, laurylbetaine, for instance the product sold under the name Genagen KB® by the company Clariant, oxyethylenated (10 OE) laurylbetaine, for instance the product sold under the name Lauryl Ether (10 OE) Betaine® by the company Shin Nihon Rica, and oxyethylenated (10 OE) stearylbetaine, for instance the product sold under the name Stearyl Ether (10 OE) Betaine® by the company Shin Nihon Rica.

Examples of alkylamphoacetates that may be mentioned include N-disodium N-cocoyl-N-carboxymethoxy-ethyl-N-carboxymethylethylenediamine (CTFA name: disodium cocoamphodiacetate), for instance the product sold under the name Miranol C2M Concentrate NP® by the company Rhodia Chimie, and N-sodium N-cocoyl-N-hydroxy-ethyl-N-carboxymethylethylenediamine (CTFA name: sodium cocoamphoacetate).

Hydroxylsultaines that may be mentioned include cocamidopropyl hydroxysultaine, for instance the product sold under the name Rewoteric AM CAS by the company Goldschmidt-Degussa.

Anionic Surfactants

Examples of anionic surfactants that may be used include carboxylates, alkyl sulfates, sulfonates, sulfosuccinates, alkylsulfoacetates, phosphates, polypeptides and anionic alkylpolyglucoside derivatives, and mixtures thereof.

Carboxylates that may be mentioned include:

Amido ether carboxylates (AEC), for instance sodium lauryl amido ether carboxylate (3 OE), sold under the name Akypo Foam 30® by the company Kao Chemicals.

Polyoxyethylenated carboxylic acid salts, for instance oxyethylenated (6 OE) sodium lauryl ether carboxylate (65/25/10 C₁₂₋₁₄₋₁₆) sold under the name Akypo Soft 45 NV® by the company Kao Chemicals, polyoxyethylenated and carboxymethylated fatty acids of olive oil origin sold under the name Olivem 400® by the company Biologia e Tecnologia, and oxyethylenated (6 OE) sodium tridecyl ether carboxylate sold under the name Nikkol ECTD-6NEX® by the company Nikkol.

Alkaline salts of N-acylamino acids,

Sarcosinates, for instance sodium lauroylsarcosinate sold under the name Sarkosyl NL 97® by the company Ciba or sold under the name Oramix L 30® by the company SEPPIC, sodium myristoyl sarcosinate sold under the name Nikkol Sarcosinate MN® by the company Nikkol, and sodium palmitoyl sarcosinate sold under the name Nikkol Sarcosinate PN® by the company Nikkol,

Alaninates, for instance sodium N-lauroyl-N-methyl-amidopropionate sold under the name Sodium Nikkol Alaninate LN 30® by the company Nikkol, or sold under the name Alanone ALE® by the company Kawaken, and N-lauroyl-N-methylalanine triethanolamine sold under the name Alanone Alta® by the company Kawaken.

Glutamates, for instance triethanolamine monococoyl-glutamate sold under the name acylglutamate CT-12® by the company Ajinomoto, and triethanolamine lauroyl-glutamate sold under the name acylglutamate LT-12 by the company Ajinomoto.

Aspartates, for instance the mixture of triethanolamine N-lauroylaspartate/triethanolamine N-myristoyl-aspartate sold under the name Asparack® by the company Mitsubishi.

Glycinates, for instance sodium N-cocoylglycinate sold under the names Amilite GCS-12® and Amilite GCK 12 by the company Ajinomoto.

Citrates, such as the citric monoester of oxyethylenated (9 mol) coconut alcohols, sold under the name Witconol EC 1129 by the company Goldschmidt.

Galacturonates such as sodium dodecyl D-galactoside uronate sold by the company Soliance.

Salts of fatty acids (soaps) containing a C6 to C22 alkyl chain, neutralized with an organic or mineral base such as potassium hydroxide, sodium hydroxide, triethanolamine, N-methylglucamine, lysine or arginine.

Examples of oxyethylenated or non-oxyethylenated alkyl sulfates that may be mentioned include sodium lauryl ether sulfate (70/30 C12-C14) (2.2 OE) sold under the name Sipon AOS 225® by the company Cognis, ammonium lauryl ether sulfate (70/30 C12-C14) (3 OE) sold under the name Sipon LEA 370® by the company Cognis, ammonium alkyl (C12-C14) ether (9 OE) sulfate sold under the name Rhodapex AB/20® by the company Rhodia Chimie, and the mixture of sodium magnesium lauryl and oleyl ether sulfate, sold under the name Empicol BSD 52 by the company Albright & Wilson.

Examples of sulfonates that may be mentioned include:

α-Olefin sulfonates, such as the sodium α-olefin sulfonate (C14-16) sold under the names Bio-Terge AS-40® and Bio-Terge AS-40 CG® by the company Stepan, or sold under the name Witconate AOS Protege®, Sulframine AOS PH 12® by the company Witco, and secondary sodium olefin sulfonate sold under the name Hostapur SAS 30® by the company Clariant.

Isethionates such as the sodium cocoylisethionate sold under the name Jordapon CI P® by the company Jordan.

Taurates such as the sodium salt of the methyltaurate of palm kernel oil, sold under the name Hostapon CT Paste® by the company Clariant, the sodium N-cocoyl-N-methyltaurate sold under the name Hostapon LT-SF® by the company Clariant, or Nikkol CMT-30-T® by the company Nikkol, and sodium palmitoyl methyltaurate sold under the name Nikkol PMT® by the company Nikkol.

Examples of sulfosuccinates that may be mentioned include the oxyethylenated (3 OE) lauryl alcohol monosulfosuccinate (70/30 C12/C14) sold under the name Setacin 103 Special® by the company Zschimmer Schwarz, or sold under the name Rewopol SB-FA 30 K 4® by the company Witco, the disodium salt of a hemisulfo-succinate of C12-C14 alcohols sold under the name Setacin F Special Paste® by the company Zschimmer Schwarz, the oxyethylenated (2 OE) disodium oleamido sulfosuccinate sold under the name Standapol SH 135® by the company Cognis, and the oxyethylenated (5 OE) laurylamide monosulfosuccinate sold under the name Lebon A-5000® by the company Sanyo.

Examples of alkylsulfoacetates that may be mentioned include the mixture of sodium lauryl sulfoacetate and disodium lauryl ether sulfosuccinate, sold under the name Stepan-Mild LSB by the company Stepan.

Examples of phosphates that may be mentioned include monoalkyl phosphates and dialkyl phosphates, for instance the lauryl monophosphate sold under the name MAP 20 by the company Kao Chemicals, the potassium salt of dodecylphosphoric acid, the mono-di-ester mixture (majority) sold under the name Crafol AP-31® by the company Cognis, octylphosphoric acid, the mono-di-ester mixture sold under the name Crafol AP-20® by the company Cognis, and the octanoethoxylated (7 mol of OE) mixture of 2-butyl monophosphoric and diphosphoric ester sold under the name Isofol 12 7 EO-Phosphate Ester® by the company Condea.

Examples of polypeptides that may be mentioned include those obtained by condensation of a fatty chain onto wheat and oat amino acids, such as the potassium salt of hydrolysed lauroyl wheat protein sold under the name Aminofoam W OR® by the company Croda, hydrolysed cocoyl soybean protein, the triethanolamine salt sold under the name May-Tein SY® by the company Maybrook, the sodium salt of oat lauroyl amino acids sold under the name Proteol Oat® by the company SEPPIC, collagen hydrolysate grafted onto coconut fatty acid sold under the name Geliderm 3000® by the company Deutsche Gelatin, and soybean proteins acylated with hydrogenated coconut acids, sold under the name Proteol VS 22® by the company SEPPIC.

Anionic alkyl polyglucoside derivatives that may be mentioned include citrates, tartrates, sulfosuccinates, carbonates and glyceryl ethers manufactured from alkyl polyglucosides, for instance the sodium salt of the tartaric ester of cocoyl polyglucoside (1.4) sold under the name Eucarol AGE-ET® by the company Cesalpinia, the disodium salt of the sulfosuccinic ester of cocoyl polyglucoside (1.4) sold under the name Essai 512 MP® by the company SEPPIC, the sodium salt of the citric ester of cocoyl polyglucoside (1.4) (1.4) sold under the name Eucarol AGE-EC® by the company Cesalpinia, and sodium lauryl polyglucoside ether carboxylate sold under the name Plantapon LGC-SORB by the company Cognis.

According to one preferred embodiment of the invention, the composition contains as additional surfactant a nonionic surfactant chosen from alkylpoly-glucosides.

### Oxyethylenated Compounds

The oxyethylenated compounds that may be used in the composition of the invention are those with a molecular weight of greater than 300 000, the molecular weight preferably ranging from 400 000 to 4×10⁶ and better still from 500 000 to 2×10⁶.

According to one preferred embodiment of the invention, the oxyethylenated compound is a compound of formula (II):

H(OCH₂CH₂)ₙOH (II)

in which n is an integer ranging from 7000 to 90 000.

As oxyethylenated compound preferably used in the composition of the invention, mention may be made especially of PEG 14M (formula (II) in which n is 14 000) such as the product sold under the name Polyox WSR 205 by the company Amerchol, PEG-45M (formula (II) in which n is 45 000) such as the product sold under the name Polyox WSR N-60 K by the company Amerchol, and mixtures thereof.

The oxyethylenated compound is present in the composition of the invention in an amount preferably ranging from 0.1% to 5% by weight and better still from 0.2% to 3% by weight relative to the total weight of the composition.

### Additives

The composition of the invention may contain any additive or active agent conventionally used in cleansing products. Examples that may be mentioned include preserving agents; sequestering agents (EDTA); antioxidants; fragrances; dyestuffs, for instance soluble dyes and pigments; nacres; mineral or organic fillers, providing viscosity, matting agents, bleaching agents or exfoliants; sunscreens; hydrophilic or lipophilic cosmetic or dermatological active agents, such as water-soluble or liposoluble vitamins, antiseptics, antiseborrhoeic agents, antimicrobial agents such as benzoyl peroxide, salicylic acid, triclosan, azelaic acid, niacinamide (vitamin PP), and also optical brighteners; fatty substances that are incompatible with the aqueous medium, for instance oils or waxes; viscosity regulators or thickeners, or other agents having the effect of improving the cosmetic properties of the hair or the skin, such as anionic, nonionic, cationic or amphoteric polymers. The amounts of these various adjuvants are those conventionally used in the field under consideration, for example from 0.01% to 20% of the total weight of the composition. These adjuvants and the concentrations thereof should be such that they do not modify the property desired for the composition of the invention.

The composition of the invention may especially contain thickeners, the amount of which depends on the viscosity desired for the final composition. The thickeners may be present in concentrations preferably ranging from 0.05% to 10% by weight and preferably ranging from 0.05% to 5% by weight relative to the total weight of the composition.

The thickener may be chosen especially from thickening polymers, particles, electrolytes (salts) and fatty amides, and mixtures thereof.

The thickening polymers may be anionic, amphoteric, cationic or nonionic, crosslinked or non-crosslinked, hydrophobic-modified or otherwise, and natural or synthetic.

Examples of thickening polymers that may be used include polymers derived from carboxylic acid, from acrylamide and/or from acrylamido-2-methylpropane-sulfonic acid. The carboxylic-derived polymer(s) may be associative polymers (i.e. polymers comprising a hydrophobic group) or nonassociative polymers, which are soluble or dispersible in water, swelling in alkaline or nonalkaline medium. They may be in the form of powder, latex or emulsion, or dispersed in water. The polymers may be nonionic, anionic, cationic, zwitterionic or amphoteric. The monomers present in the polymers are preferably chosen from styrene, butadiene, ethylene, acrylonitrile, chloroprene, vinylidene chloride, isoprene, isobutylene and vinyl chloride monomers, and acrylic, methacrylic, vinylacetic, maleic, crotonic and itaconic acid ester monomers. These monomers may be used alone or in combination or may be mixed with one or more ionic monomers, for instance acrylic or methacrylic acids in charged form.

The preferred anionic polymers contain a monomer derived from acrylic or methacrylic acid and are partially neutralized, for instance the polymers sold under the names Carbopol 981 and Carbopol 1382 by the company Noveon, and the polymer sold under the name Acrysol 22 by the company Röhm & Haas.

Nonionic thickening polymers that may be used include oxyalkylenated derivatives of fatty acid esters or of fatty alkyl ethers, or polysaccharides. Oxyalkylenated derivatives of fatty acid esters or of fatty alkyl ethers that may especially be mentioned include the ethoxylated alkyl or acyl derivatives of polyols, which may in particular be oxyethylenated derivatives of C6-C30 fatty acid esters or of C6-C30 fatty alkyl ethers, and of polyols such as glycerol, sorbitol, glucose or pentaerythritol, these oxyethylenated derivatives generally comprising from 50 to 500 oxyethylene groups and preferably from 100 to 300 oxyethylene groups. Examples of compounds of this type that may be mentioned include oxyethylenated (200 OE) glyceryl stearate such as the product sold under the name Simulsol 220 TM® by the company SEPPIC, oxyethylenated (150 OE) pentaerythrityl tetrastearate such as the product sold under the name Crothix® by the company Croda, oxyethylenated (120 OE) methylglucose dioleate such as the product sold under the name Glucamate DOE-120 Vegetal® by the company Amerchol, oxyethylenated (160 OE) sorbitan triisostearate such as the product sold under the name Rheodol TW IS399C by the company Kao Chemicals, and mixtures thereof. Polysaccharides that may be mentioned include xanthan gum and similar gums, and cellulose derivatives, for instance the cetyl hydroxyethylcellulose sold under the name Natrosol Plus Grade 330 CS by the company Hercules, and mixtures thereof.

Particles for thickening the formulations that may be used include clays, for instance hectorites such as Bentone MA sold by the company Elementis Specialities.

Examples of fatty amides that may be used include cocamide MEA and cocamide MIPA, and mixtures thereof.

Examples of electrolytes that may be used include sodium chloride, potassium chloride, magnesium chloride, and similar salts, and mixtures thereof.

The compositions according to the invention are stable, give a fine foam and have very good rinsability. They may constitute, for example, a cleansing and/or makeup-removing product for the skin, the scalp and/or the hair, a scrubbing product and/or an exfoliant product for the skin. They may more particularly constitute a skin cleansing composition.

Another subject of the invention is the cosmetic use of the composition as defined above, as a cleansing and/or makeup-removing product for the skin, the scalp and/or the hair, and/or as a scrubbing product and/or an exfoliant product for the skin.

The compositions according to the invention may be used in at least two ways:
one use involves spreading the gel between the hands, applying it to the face or the body and then working it in the presence of water to develop the foam directly on the face or the body,
another use of this type of product involves developing the foam in the palms of the hands before applying it to the face or body.
   In both cases, the foam may then be rinsed off.

The compositions according to the invention may also constitute a composition for treating greasy skin, especially when they contain a specific active agent for treating greasy skin, for instance salicylic acid, azelaic acid, triclosan, piroctone olamine or niacinamide (vitamin PP).

Another subject of the invention is the use of the composition as defined above for the preparation of a composition for treating greasy skin.

The examples that follow serve to illustrate the invention without, however, being limiting in nature. The amounts indicated are weight percentages, unless otherwise mentioned.

In the table of the examples, all the percentages are expressed by weight of active material (AM).

### Sensory Performance

For some of the examples, the sensory performance of the compositions (foam qualities) were determined according to the protocol described below.

Before any use of the product, the hands are washed with household soap and then appropriately rinsed and dried. The protocol then followed is as follows:

1—wet the hands by passing them under running water, and shake them three times to drain them,
2—place 1 g of product in the palm of one of the hands,
3—work the product between the two palms for 10 seconds,
4—add 2 ml of water and work the product again for 10 seconds,
5—work the product again for 10 seconds,
6—add 2 ml of water and work the product again for 10 seconds,
7—rinse the hands in water,
8—wipe them.

The criteria are evaluated at each step of the protocol followed, and they are graded on a scale from 0 to 10.
Steps 4-5: evaluation of the foam quality (step 6)
The volume of foam: the grade allocated is higher the greater the volume.
The size of the bubbles of which the foam is composed: the grade allocated is higher the larger the bubbles.
The behaviour of the foam: the grade allocated is higher the more elastic the form and if it does not run.
Step 7: evaluation during rinsing
The rinsing: the grade allocated is lower the greater the presence of a slippery film that is difficult to remove, which means that the grade is higher the more easily the product rinses off without leaving a film.

The evaluation panel consisted of four trained experts. The average of the four grades allows a comparison of the compositions according to each of the criteria.

### Examples 1 and 2 According to the Invention and Comparative Examples 1 to 3

| | Example 1 | Example 2 | | | |
|---|---|---|---|---|---|
| | according | according | | | |
| | to the | to the | Comparative | Comparative | Comparative |
| Composition | invention | invention | example 1 | example 2 | example 3 |
| Sodium lauryl glycol carboxylate (1) | 7.8 | 7.8 | 7.8 | 7.8 | 7.8 |
| Cocoglucoside (2) | 6.5 | 6.5 | 6.5 | 6.5 | 6.5 |
| PEG-5M (MW = 220018) (3) | 0 | 0 | 0 | 1 | 0 |
| PEG-14M (MW = 616018) (4) | 1 | 0 | 0 | 0 | 0 |
| PEG-45M (MW = 1 980 018) (5) | 0 | 1 | 0 | 0 | 0 |
| PEG-180 (MW = 7938) (6) | 0 | 0 | 1 | 0 | 0 |
| Citric acid | 0.18 | 0.3 | 0.13 | 0.3 | 0.10 |
| DDM hydantoin | 0 | 0.2 | 0.2 | 0.2 | 0.2 |
| Sodium methyl paraben | 0 | 0.3 | 0.3 | 0.3 | 0.3 |
| Imidazolidinylurea | 0.2 | 0 | 0 | 0 | 0 |
| Water | qs 100% | qs 100% | qs 100% | qs 100% | qs 100% |
| Appearance of the | One | One | One | One | One |
| composition | transparent | transparent | transparent | transparent | transparent |
| | phase | phase | phase | phase | phase |
| pH | 7.1 | 6.9 | 6.8 | 7 | 7.2 |
| Bubble size | 4.2 | 3.5 | 4.9 | 4.4 | 5.1 |
| Volume of foam | 6.1 | 5.5 | 8.25 | 6.5 | 7 |
| Foam behaviour | 8.4 | 8.7 | 8 | 8.2 | 8 |
| Softness | 10 | 10 | 7.5 | 8 | 7.5 |
| Rinsing | 8.5 | 9 | 8.5 | 9.5 | 9.4 |

(1) Beaulight SHAA (Sanyo) at 30% active material, introduced in an amount adequate to give the percentage of active material indicated in the table
(2) Plantacare 818 UP (Cognis) at 53% active material, introduced in an amount adequate to give the percentage of active material indicated in the table
(3) Polyox resin WSR N80 (Amerchol) at 100% active material
(4) Polyox WSR 205 (Amerchol) at 100% active material
(5) Polyox WSR N-60 K (Amerchol) at 100% active material
(6) (K-PEG 6000 LA) (Kao) at 100% active material

Comparison of Examples 1 and 2 according to the invention and of the comparative examples shows that the addition of oxyethylenated compound of molecular weight greater than 500 000 to an anionic surfactant of the Beaulight type gives finer foams (smaller bubble sizes) and great softness while at the same time conserving good foam behaviour and good rinsing, whereas the same result is not obtained with an oxyethylenated compound having a molecular weight of less than 100 000.

### Examples 3 and 4 According to the Invention and Comparative Examples 4 to 6

| | Example 3 | Example 4 | | | |
|---|---|---|---|---|---|
| | according | according | | | |
| | to the | to the | Comparative | Comparative | Comparative |
| | invention | invention | example 4 | example 5 | example 6 |
| Sodium lauryl glycol carboxylate (1) | 3.9 | 7.8 | 0 | 0 | 0 |
| Monoalkyl phosphate (2) | 0 | 0 | 0 | 0 | 6.5 |
| Decyl glucoside (3) | 0 | 6.5 | 0 | 13 | 6.5 |
| Cocoamidopropylbetaine (4) | 3.25 | 0 | 6.5 | 0 | 0 |
| PEG-150 pentaerythrityl tetrastearate | 1 | 0 | 1 | 0 | 0 |
| PEG-120 methylglucose dioleate | 1 | 0 | 1 | 0 | 0 |
| PEG-14M (5) | 1 | 1 | 1 | 1 | 1 |
| Glycerol | 10 | 0 | 10 | 0 | 0 |
| Citric acid | 0.08 | 0.14 | 0.124 | 0.03 | 0.16 |
| Imidazolidinylurea | 0 | 0.2 | 0 | 0.2 | 0.2 |
| Phenoxyethanol/methyl paraben/ethyl | 0 | 0.5 | 0 | 0.5 | 0.5 |
| paraben/butyl paraben/isobutyl | | | | | |
| paraben/propyl paraben | | | | | |
| DDM hydantoin | 0.2 | 0.2 | 0.2 | 0 | 0 |
| Sodium methyl paraben | 0.3 | 0.3 | 0.3 | 0 | 0 |
| Water | qs 100% | qs 100% | qs 100% | qs 100% | qs 100% |
| Appearance of the | 1 transparent | 1 transparent | 2 phases | 2 phases | 2 phases |
| product | phase | phase | | | |
| pH | 6.8 | 7.2 | 6.85 | 6.8 | 7.4 |

(1) Beaulight SHAA (Sanyo) at 30% active material, introduced in an amount adequate to give the percentage of active material indicated in the table
(2) MAP 20 (Kao) (100% active material)
(3) Mydol 10 (Kao) at 40% active material, introduced in an amount adequate to give the percentage of active material indicated in the table
(4) Tegobetaine E (Goldschmidt) at 31% active material, introduced in an amount adequate to give the percentage of active material indicated in the table
(5) Polyox WSR 205 (Amerchol) at 100% active material

This table shows that the introduction of oxyethylenated compound of high molecular weight into foaming compositions generally causes phase separations, whether the surfactant present in the composition is amphoteric (comparative example 4), nonionic (comparative example 5) or a mixture of anionic and nonionic surfactant (comparative example 6). On the other hand, in the presence of an alkyl glycol carboxylate, this phase separation does not take place.

### Examples 5 and 6 According to the Invention and Comparative Examples 6 and 7

| | Example 5 | | Example 6 | |
|---|---|---|---|---|
| | according | Compara- | according | Compara- |
| | to the | tive | to the | tive |
| | invention | example 7 | invention | example 8 |
| Sodium lauryl glycol | 15.6 | 15.6 | 3.9 | 3.9 |
| carboxylate (1) | | | | |
| Cocoglucoside (2) | 0 | 0 | 3.25 | 3.25 |
| PEG-14M (3) | 1 | 0 | 1 | 0 |
| PEG-150 pentaerythrityl | 0 | 0 | 1 | 1 |
| tetrastearate | | | | |
| PEG-120 methylglucose | 0 | 0 | 0.5 | 0.5 |
| dioleate | | | | |
| Glycerol | 0 | 0 | 10 | 10 |
| Citric acid | 0.06 | 0.03 | 0.17 | 0.19 |
| DDM hydantoin | 0 | 0 | 0.2 | 0.2 |
| Sodium methyl paraben | 0 | 0 | 0.3 | 0.3 |
| Imidazolidinylurea | 0.2 | 0.2 | 0 | 0 |
| Phenoxyethanol, methyl | 0.5 | 0.5 | 0 | 0 |
| paraben, ethyl paraben, | | | | |
| butyl paraben, butyl | | | | |
| paraben and propyl | | | | |
| paraben mixture | | | | |
| Water | qs 100% | qs 100% | qs 100% | qs 100% |
| Appearance of the | One trans- | One trans- | One trans- | One trans- |
| product | parent | parent | parent | parent |
| | phase | phase | phase | phase |
| pH | 7.25 | 7.3 | 7.2 | 6.5 |
| Bubble size | 3.4 | 4.8 | 2.5 | 4.3 |
| Volume of foam | 5.6 | 6.9 | 4.5 | 5 |
| Foam behaviour | 7.9 | 7.5 | 8.2 | 6.8 |
| Softness | 9.5 | 7.5 | 9.3 | 7.5 |
| Rinsing | 8.1 | 8.5 | 8.2 | 8 |

(1) Beaulight SHAA (Sanyo) at 30% active material, introduced in an amount adequate to give the percentage of active material indicated in the table
(2) Plantacare 818 UP (Cognis) at 53% active material, introduced in an amount adequate to give the percentage of active material indicated in the table
(3) Polyox WSR 205 (Amerchol) at 100% active material

This table demonstrates the advantages of the compositions according to the invention (better bubble size, better foam behaviour, better softness).

### Example 7 According to the Invention and Comparative Example 9

| | Example 7 | |
|---|---|---|
| | according to | Comparative |
| Composition | the invention | example 9 |
| Sodium lauryl glycol carboxylate (1) | 2.2 | 2.2 |
| Cocoglucoside (2) | 4.3 | 4.3 |
| PEG-14M (3) | 1 | 0 |
| PEG-150 pentaerythrityl tetrastearate | 1 | 1 |
| PEG-120 methylglucose dioleate | 0.5 | 0.5 |
| Glycerol | 10 | 10 |
| Citric acid | 0.19 | 0.19 |
| DDM hydantoin | 0.2 | 0.2 |
| Sodium methyl paraben | 0.3 | 0.3 |
| Water | qs 100% | qs 100% |
| Appearance of the product | One transparent | One transparent |
| | phase | phase |
| pH | 6.8 | 6.8 |
| Bubble size | 3.4 | 4.5 |
| Volume of foam | 4.9 | 5.3 |
| Foam behaviour | 7.9 | 7.4 |
| Rinsing | 8.4 | 8.4 |

(1) Beaulight SHAA (Sanyo) at 30% active material, introduced in an amount adequate to give the percentage of active material indicated in the table
(2) Plantacare 818 UP (Cognis) at 53% active material, introduced in an amount adequate to give the percentage of active material indicated in the table
(3) Polyox WSR 205 (Amerchol) at 100% active material

Comparison of the example according to the invention and of the comparative example of this table shows that the addition of oxyethylenated compounds of high molecular weight improves the fineness of the foam (small bubble sizes) and the foam behaviour, while at the same time conserving the transparency of the composition.

### Example 8 According to the Invention and Comparative Example 10

| | Example 8 | |
|---|---|---|
| | according to | Comparative |
| Composition | the invention | example 10 |
| Sodium lauryl glycol carboxylate (1) | 3.9 | 3.9 |
| Cocoamidopropylbetaine (2) | 3.25 | 3.25 |
| PEG-14M (3) | 1 | 0 |
| PEG-150 pentaerythrityl tetrastearate | 1 | 1 |
| PEG-120 methylglucose dioleate | 1 | 1 |
| Glycerol | 10 | 10 |
| Citric acid | 0.1 | 0.09 |
| DDM hydantoin | 0.2 | 0.2 |
| Sodium methyl paraben | 0.3 | 0.3 |
| Water | qs 100% | qs 100% |
| Appearance of the product | One transparent | One transparent |
| | phase | phase |
| pH | 7.2 | 7.1 |
| Bubble size | 3.3 | 4.4 |
| Volume of foam | 5.8 | 5.8 |
| Foam behaviour | 8.8 | 7.5 |
| Rinsing | 7.2 | 7.9 |

(1) Beaulight SHAA (Sanyo) at 30% active material, introduced in an amount adequate to give the percentage of active material indicated in the table
(2) Tegobetaine E (Goldschmidt) at 31% active material, introduced in an amount adequate to give the percentage of active material indicated in the table
(3) Polyox WSR 205 (Amerchol) at 100% active material

This table shows that the introduction of an oxyethylenated compound of high molecular weight improves the foam quality (bubble size, foam behaviour, softness) of foaming systems, while at the same time conserving their transparency.

The above written description of the invention provides a manner and process of making and using it such that any person skilled in this art is enabled to make and use the same, this enablement being provided in particular for the subject matter of the appended claims, which make up a part of the original description and including a cleansing composition for topical application, containing, in a physiologically acceptable aqueous medium, at least one anionic surfactant chosen from alkyl glycol carboxylic acids and salts thereof, and at least one oxyethylenated compound with a molecular weight of greater than or equal to 300 000 g/mol.

As used above, the phrases “selected from the group consisting of,” “chosen from,” and the like include mixtures of the specified materials.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out. Terms such as “contain(s)” and the like as used herein are open terms meaning ‘including at least’ unless otherwise specifically noted.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A composition comprising, in a physiologically acceptable aqueous medium, at least one anionic surfactant chosen from alkyl glycol carboxylic acids and salts thereof, and at least one oxyethylenated compound with a molecular weight of greater than or equal to 300 000 g/mol.

2. The composition according to claim 1, wherein the anionic surfactant is present in an amount of 0.5% to 20% by weight relative to the total weight of the composition.

3. The composition according to claim 1, comprising at least one anionic surfactant of formula (I):
R₁—CHOH—CH₂—O—CH₂—COO⁻X⁺ (I)
in which R₁ denotes a saturated or unsaturated, linear or branched alkyl radical containing from 8 to 30 carbon atoms and X denotes hydrogen or a mineral or organic cation.

4. The composition according to claim 3, wherein R₁ denotes a saturated or unsaturated, linear or branched alkyl radical containing from 8 to 18 carbon atoms.

5. The composition according to claim 1, comprising anionic surfactant sodium lauryl glycol carboxylate, its acid form, or both.

6. The composition according to claim 1, further comprising one or more additional surfactants chosen from nonionic, amphoteric and anionic surfactants, and mixtures thereof.

7. The composition according to claim 1, further comprising at least one nonionic surfactant chosen from alkylpolyglucosides.

8. The composition according to claim 1, wherein the total amount of surfactants is 2% to 50% by weight relative to the total weight of the composition.

9. The composition according to claim 6, comprising at least one anionic surfactant chosen from alkyl glycol carboxylic acids and salts thereof, wherein the weight ratio of the anionic surfactant chosen from alkyl glycol carboxylic acids and salts thereof relative to the other surfactants ranges from 100/0 to 10/90.

10. The composition according to claim 1, wherein the amount of oxyethylenated compound is 0.1% to 3% by weight relative to the total weight of the composition.

11. The composition according to claim 1, wherein the oxyethylenated compound is a compound of the following formula:
H(OCH₂CH₂)ₙOH
in which n is an integer ranging from 7000 to 90,000.

12. The composition according to claim 1, comprising at least one chosen from PEG-14M and PEG-45M, and mixtures thereof.

13. The composition according to claim 1, wherein
said composition comprises at least one anionic surfactant of formula (I):
R₁—CHOH—CH₂—O—CH₂—COO⁻X⁺ (I)
in which R₁ denotes a saturated or unsaturated, linear or branched alkyl radical containing from 8 to 30 carbon atoms and X denotes hydrogen or a mineral or organic cation, and
said composition comprises at least one oxyethylenated compound of the following formula:
H(OCH₂CH₂)ₙOH
in which n is an integer ranging from 7000 to 90,000.

14. The composition according to claim 13, wherein the anionic surfactant is present in an amount of 0.5% to 20% by weight relative to the total weight of the composition, and the amount of oxyethylenated compound is 0.1% to 3% by weight relative to the total weight of the composition.

15. The composition according to claim 13, further comprising at least one nonionic surfactant chosen from alkylpolyglucosides.

16. The composition according to claim 14, further comprising at least one nonionic surfactant chosen from alkylpolyglucosides.

17. A method, comprising applying the composition of claim 1 to the skin, the scalp and/or the hair.

18. A method according to claim 17, wherein said method is a method for cleansing the skin, scalp and/or the hair, or for removing makeup from the skin, or for scrubbing and/or exfoliating the skin.

19. A method, comprising applying the composition of claim 13 to the skin, the scalp and/or the hair.

20. A method, comprising applying the composition of claim 14 to the skin, the scalp and/or the hair.
